(19) United States
(12) Patent Application Publication
(10) Pub. No.: US 2009/0284510 A1
(43) Pub. Date: Nov. 19, 2009

(54) AC PLASMA DISPLAY PANEL DRIVING METHOD

(75) Inventors: Kenji Sasaki, Osaka (JP); Kenji Ogawa, Osaka (JP); Yoshiki Tsujita, Osaka (JP); Toru Ando, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/571,388

(22) PCT Filed: Mar. 29, 2006
(86) PCT No.: PCT/JP2006/306444

§ 371 Date: Dec. 28, 2006

(30) Foreign Application Priority Data
Mar. 31, 2005 (JP) 2005-102212

(51) Int. Cl. G09G 5/00; G09G 3/28

(52) U.S. Cl. 345/211; 345/60

(57) ABSTRACT

In a method of driving an AC plasma display panel of the present invention, one field period is made of a plurality of sub-fields (SFs), each including an initializing period, writing period, and sustaining period, and a part of sustaining operation in the sustaining period in at least one of the plurality of SFs and a part of selective initializing operation in the initializing period in a SF following the at least one SF are performed at the same time. The method comprises making a pulse width of a top sustain pulse in one of the sustaining periods in the plurality of SFs different from that in another of the sustaining periods therein. This method limits the SFs in which any erroneous discharge occurs to lower order of SFs and can inhibit the brightness of the erroneous discharge.

### TECHNICAL FIELD

The present invention relates to a method of driving a plasma display panel used as a thin display device having a large screen and light weight.

### BACKGROUND ART

An alternating current (AC) surface-discharging panel representing a plasma display panel (hereinafter abbreviated as a panel) has a large number of discharge cells formed between a facing front substrate and rear substrate. In the front substrate, a plurality of display electrodes, each formed of a pair of scan electrode and sustain electrode, are formed on a front glass substrate in parallel with each other. A dielectric layer and a protective layer are formed to cover these display electrodes. On the other hand, in the rear substrate, a plurality of data electrodes are formed in parallel with each other on a rear glass substrate. A dielectric layer is formed on the data electrodes to cover them. Further, a plurality of barrier ribs are formed on the dielectric layer in parallel with the data electrodes. Phosphor layers are formed on the surface of the dielectric layer and the side faces of the barrier ribs. Then, the front substrate and the rear substrate are faced with each other and sealed together so that the display electrodes and data electrodes intersect with each other and a discharge gas is filled in an internal discharge space formed therebetween and partitioned by the barrier ribs. A discharge cell is formed in a part where a display electrode is faced with a corresponding data electrode. In a panel structured as above, ultraviolet light is generated by gas discharge in each discharge cell. This ultraviolet light excites respective phosphors to emit R, G, or B color, for color display.

A general method of driving a panel is a so-called sub-field method (SF method): one field period is divided into a plurality of sub-fields (SFs) and combination of light-emitting SFs provides gradation images for display. Among such SF methods, a novel driving method of minimizing light emission unrelated to gradation representation to inhibit increases in black picture level and improve a contrast ratio is disclosed in Japanese Patent Unexamined Publication No. 2000-242224.

The method of driving the panel is described with reference to FIG. 7. FIG. 7 is a driving timing chart showing how to drive a conventional AC plasma display panel. In FIG. 7, each SF includes an initializing period, wiring period, and sustaining period. In the initializing period, one of all-cell initializing operation and selective initializing operation is performed. In the all-cell initializing operation, initializing discharge is performed on all the discharge cells to display images. In the selective initializing operation, selective initializing operation is performed on the discharge cells that have undergone sustaining discharge in the SF immediately before.

First, in the period of all-cell initializing operation, initializing discharge is performed on all the discharge cells at one time, to erase the wall electric charge that has accumulated in each of the cells and to form wall charges necessary for the following writing operation. In addition, the all-cell initializing operation also works to generate priming particles (initiating agent, i.e. excited particles) for minimizing discharge delay and causing a stable writing discharge.

In the following writing period, scan pulses are sequentially applied to the scan electrodes, and write pulses corresponding to the image signals to be displayed are applied to the data electrodes. Then, selective writing discharge occurs between the scan electrodes and the corresponding data electrodes that have received the write pulses, so that wall charges are formed.

In the sustaining period, a predetermined number of sustain pulses are applied between the scan electrodes and the corresponding sustain electrodes according to the brightness weights thereof to selectively discharge the discharge cells having wall charges formed thereon by the writing operation.

As described above, to properly display an image, ensuring selective writing operation in the writing period is important. For this purpose, securely performing the initializing operation, i.e. preparation for writing operation, is important.

However, in the above driving method, it is necessary to perform initializing discharge using the scan electrodes as anodes and the sustain electrodes and data electrodes as cathodes in the all-cell initializing operation. Because phosphor layers having a smaller electron emission coefficient are applied to the side of the data electrodes, the delay in initial discharge using the data electrodes as cathodes is likely to increase. Additionally, in recent years, a discussion has been taking place about improvement in the luminous efficiency of a panel by increasing the partial pressure of xenon sealed into the panel. Increasing the partial pressure of xenon is likely to increase the delay in initializing discharge. Further, when displaying state (discharge) is continued for a long period in the respective discharge cells, the delay in the cells increases. In this manner, when the discharge delay in the discharge cells is large, the initializing discharge is unstable. Thus, the initializing discharge, which should be weak, can be strong in the discharge cells.

When the discharge delay is large, writing discharge performed only on the discharge cells to be lit during the writing period is unstable. This sometimes hinders the sustaining discharge from being caused in the following sustaining period. In this case, because the state is changed to the following initializing period with positive wall voltage accumulating on the scan electrodes and negative wall voltage on the sustain electrodes, strong discharge occurs in the selective initializing operation.

When the initializing discharge is strong as described above, excessive positive wall voltage accumulates on the scan electrodes. For this reason, although having performed no writing operation in the following writing period, the discharge cells perform sustaining discharge in the sustaining period. In other words, erroneous discharge in which discharge cells not to be displayed light occurs. Particularly in the latter half of SFs with a larger number of sustain pluses, a larger number of sustain pulses applied to the discharge cells adjacent to those having undergone writing operation cause more sustaining discharge, thus generating more priming particles. Supplying priming particles from these adjacent discharge cells to the discharge cells that have performed no sustaining discharge decreases the discharge-starting voltage of the discharge cells, thereby causing erroneous discharge more easily. The erroneous discharge is brighter at a larger number of sustain pulses. Therefore, the erroneous discharge in the latter half of SFs having higher brightness weights is considerably prominent.

### SUMMARY OF THE INVENTION

According to one aspect of the present invention, there is provided of a method of driving an AC plasma display panel, in which one field period is made of a plurality of sub-fields (SFs), each including an initializing period, writing period, and sustaining period, and a part of sustaining operation in the sustaining period in at least one of the plurality of SFs and a part of selective initializing operation in the initializing period in a SF following the at least one SF are performed at the same time. The method comprises making a pulse width of a top sustain pulse in one of the sustaining periods in the plurality of SFs different from that in another of the sustaining periods therein.

According to another aspect of the present invention, there is provided a method of driving an AC plasma display panel, in which one field period is made of a plurality of sub-fields (SFs), each including an initializing period, writing period, and sustaining period, and a part of sustaining operation in the sustaining period in at least one of the plurality of SFs and a part of selective initializing operation in the initializing period in a SF following the at least one SF are performed at the same time. The method comprises varying the pulse widths of the top sustain pulses in the sustaining periods with temperatures of the device.

### BRIEF DESCRIPTION OF THE DRAWINGS

FIG. 1 is a perspective view in section of a part of an AC plasma display panel in accordance with a first exemplary embodiment of the present invention.

FIG. 2 is a diagram illustrating an array of electrodes of the AC plasma display panel in accordance with the first exemplary embodiment of the present invention.

FIG. 3 is a circuit block diagram of an AC plasma display device in accordance with the first exemplary embodiment of the present invention.

FIG. 4 is a driving timing chart showing a method of driving an AC plasma display device in accordance with the first exemplary embodiment of the present invention.

FIG. 5 is a circuit block diagram of a plasma display device in accordance with a second exemplary embodiment of the present invention.

FIG. 6 is a table showing an example of settings of temperatures and pulse widths of the top sustain pulses of the plasma display device in accordance with the second exemplary embodiment of the present invention.

FIG. 7 is a driving timing chart showing a method of driving a conventional AC plasma display panel.

### REFERENCE MARKS IN THE DRAWINGS

1 Plasma display panel
2 Front substrate
3 Rear substrate
4 Scan electrode
5 Sustain electrode
6 Dielectric layer
7 Protective layer
8 Insulating layer
9 Data electrode
10 Barrier rib
11 Phosphor layer
12 Data driver circuit
13 Scan driver circuit
14 Sustain driver circuit
15 Timing generation circuit
16 Analog-to-digital (A/D) converter
17 Line number converter
18 Sub-field (SF) converter
19 Device temperature detector
20 Sustain pulse width setting part

### DETAILED DESCRIPTION OF PREFERRED EMBODIMENTS

### First Exemplary Embodiment

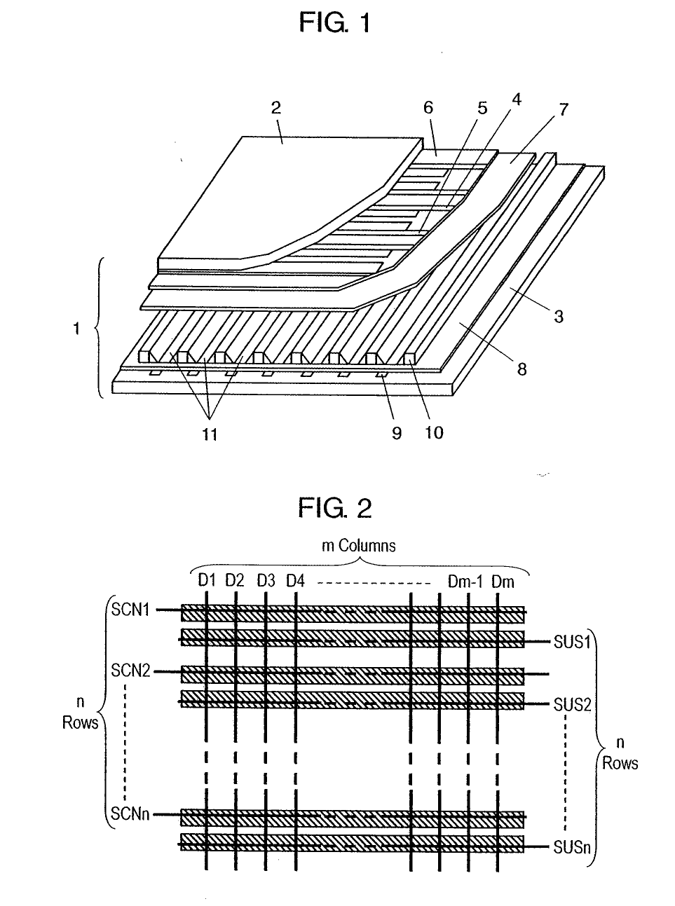

FIG. 1 is a perspective view illustrating an essential part of an AC plasma display panel (hereinafter referred to as a panel) in accordance with the first exemplary embodiment of the present invention. Panel 1 is composed of front substrate 2 and rear substrate 3 that are made of glass and faced with each other so as to form a discharge space therebetween. On front substrate 2, a plurality of display electrodes, each formed of a pair of scan electrode 4 and sustain electrode 5, are formed in parallel with each other. Dielectric layer 6 is formed to cover scan electrodes 4 and sustain electrodes 5. On dielectric layer 6, protective layer 7 is formed. As protective layer 7, materials having a high secondary electron emission coefficient and sputter resistance are desirable. In the first exemplary embodiment, an MgO thin film is used. On the other hand, on rear substrate 3, a plurality of data electrodes 9 are provided in parallel with each other. Data electrodes 9 are covered with insulating layer 8. Barrier ribs 10 are provided on insulating layer 8 between data electrodes 9 in parallel therewith. Also, phosphor layers 11 are provided on the surface of insulating layer 8 and the side faces of barrier ribs 10. Front substrate 2 and rear substrate 3 are faced with each other in a direction in which scan electrodes 4 and sustain electrodes 5 intersect with data electrodes 9. In a discharge space formed therebetween, a mix gas, e.g. neon-xenon, is filled as a discharge gas.

FIG. 2 is a diagram showing an array of electrodes on the panel in accordance with the first exemplary embodiment of the present invention. N scan electrodes SCN 1 to SCNn (scan electrodes 4 in FIG. 1) and n sustain electrodes SUS 1 to SUSn (sustain electrodes 5 in FIG. 1) are alternately disposed in a row direction. M data electrodes D1 to Dm (data electrodes 9 in FIG. 1) are disposed in a column direction. A discharge cell is formed at a portion in which a pair of scan electrode SCNi and sustain electrode SUSi (i=1 to n) intersects with one data electrode Dj (j=1 to m). Thus, m×n discharge cells are formed in the discharge space.

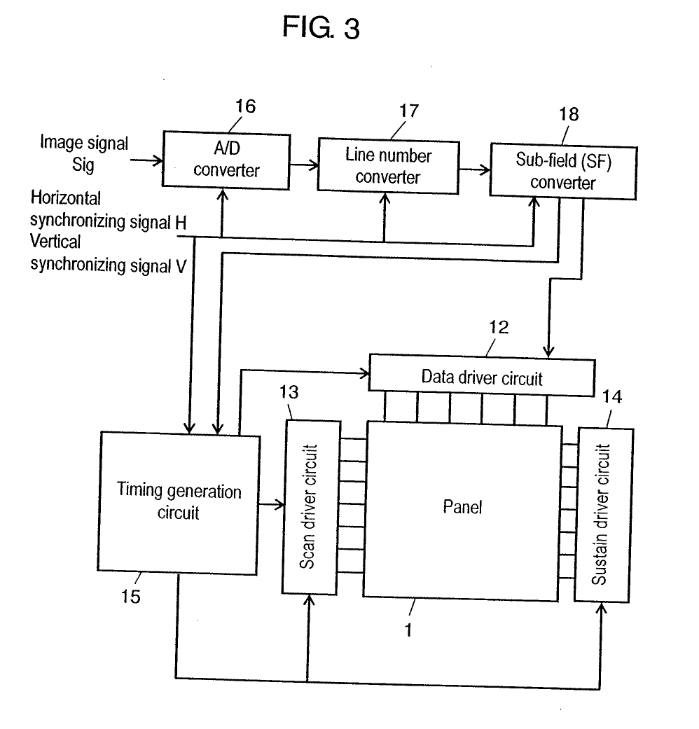

FIG. 3 is a diagram illustrating a circuit block diagram of a plasma display device used to implement a method of driving a panel in accordance with the first exemplary embodiment of the present invention. The plasma display panel of FIG. 3 includes panel 1, data driver circuit 12, scan driver circuit 13, sustain driver circuit 14, timing generation circuit 15, analog-to-digital (A/D) converter 16, line number converter 17, and sub-field (SF) converter 18, and power supply circuits (not shown).

With reference to FIG. 3, video signal Sig is fed into A/D converter 16. Horizontal synchronizing signal H and vertical synchronizing signal V are fed into timing generation circuit 15, A/D converter 16, line number converter 17, and SF converter 18. A/D converter 16 converts video signal Sig into image data of digital signals, and feeds the digital image data into line number converter 17. Line number converter 17 converts the image data into respective image data corresponding to the number of pixels of panel 1, and feeds the image data to SF converter 18. SF converter 18 generates bit data corresponding to a plurality of SFs in which image data of respective pixels are to be lit, and image data per SF, and feeds the bit data to data driver circuit 12. Data driver circuit 12 converts the image data per SF into signals corresponding to respective data electrodes D1 to Dm, and drives the respective data electrodes.

Timing generation circuit 15 generates timing signals based on horizontal synchronizing signal H and vertical synchronizing signal V, and feeds the timing signals to scan driver circuit 13 and sustain driver circuit 14, respectively. Responsive to the timing signals, scan driver circuit 13 feeds driving waveforms into scan electrodes SCN1 to SCNn. Responsive to the timing signals, sustain driver circuit 14 feeds driving waveforms into scan electrodes SUS1 to SUSn.

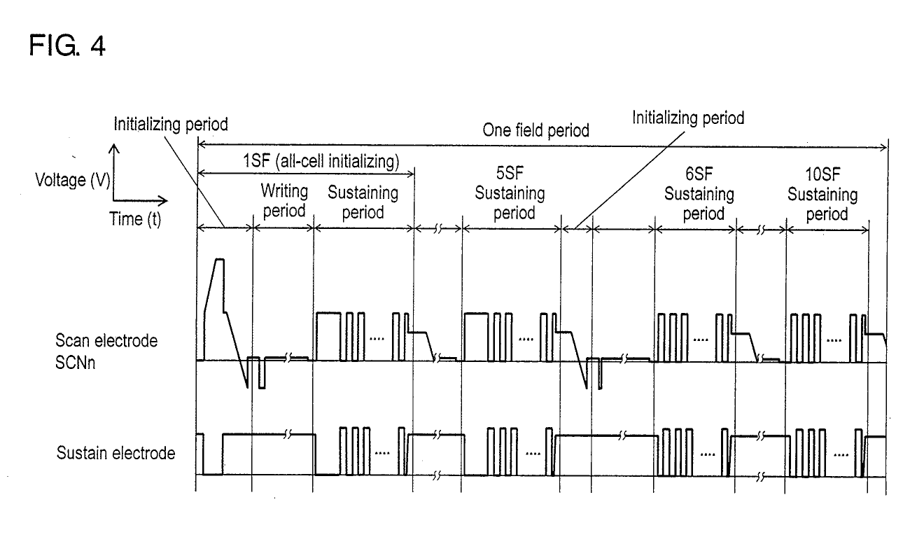

Next, driving waveforms for driving the panel and operation thereof are described. FIG. 4 is a driving timing chart showing the method of driving the panel in accordance with the first exemplary embodiment of the present invention. In the first exemplary embodiment, one field is divided into 10 SFs (a first SF, second SF . . . tenth SF) so that the respective SFs have the following brightness weights: 1, 2, 3, 6, 11, 18, 30, 44, 60, and 80. In this manner, one field is structured so that later SFs have a higher value of brightness weight (a higher brightness). However, the number of SFs and the brightness weight of each SF are not limited to the above values.

In the first exemplary embodiment of the present invention, the pulse width of the top sustain pulse in each sustaining period in the first to fifth SFs is larger than those in the other SFs. In this embodiment, the advantages of this structure are described, and descriptions of the other driving waveforms and operation thereof are omitted because they are similar to those of the conventional art.

When a gradually-increasing ramp voltage is applied to scan electrodes SCN1 to SCNn in an initializing period, generally, weak initializing discharge occurs using scan electrodes SCN1 to SCNn as anodes and sustain electrodes SUS1 to SUSn as cathodes. However, when the partial pressure of xenon is high, the discharge delay increases. Particularly in the case of insufficient priming particles, even when the surfaces of sustain electrodes SUS1 to SUSn, i.e. the cathodes, are covered with protective layer 7 having a large secondary electron emission coefficient, large discharge delay can occur.

Then, because the gradually-increasing ramp voltage is applied to scan electrodes SCN1 to SCNn, when the discharge occurs with delay, a voltage considerably exceeding the discharge-starting voltage is applied to the discharge cells. This voltage causes strong discharge instead of weak discharge between scan electrodes SCN1 to SCNn and sustain electrodes SUS1 to SUSn the most adjacent to each other. Alternatively, strong discharge occurs using scan electrodes SCN1 to SCNn as anodes, and data electrodes D1 to Dm as cathodes, preceding the former discharge between the scan electrodes and sustain electrodes. Then, excessive negative wall charges accumulate on scan electrodes SCN 1 to SCNn. As a result, while a gradually-decreasing ramp waveform is applied in the initializing period for performing selective initializing operation, strong discharge occurs again and excessive positive wall charges accumulate on scan electrodes SCN1 to SCNn. In some case, the writing discharge occurring during the writing period in the SF preceding the SF for performing the all-cell initializing operation is weak, and wall voltage to accumulate on the scan electrodes, sustain electrodes, or data electrodes is insufficient. As a result, in the discharge cells that have performed no sustain discharge during the following sustaining period, abnormal wall charges remain. In other cases, when writing discharge itself occurs normally but decreases in the wall voltage accumulating on the scan electrodes, sustain electrodes, or data electrodes for some reasons cause no sustaining discharge, abnormal wall charges similarly remain in the discharge cells.

In these above cases, even in the discharge cells not to be displayed originally, i.e. those having undergone no writing operation during the writing period, this abnormal wall voltage causes a sustaining discharge during the sustaining period, i.e. an erroneous discharge. In this erroneous discharge, the remaining abnormal wall voltage less sufficient than the wall voltage after normal writing operation causes a large discharge delay. These discharge cells are not discharged by sustain pulses in the SF for performing no normal writing operation immediately after the erroneous discharge. In a SF several SFs after that, in which many sustain pulses that have strong influences of priming particles from the adjacent discharge cells are applied, these discharge cells are likely to discharge even when no normal writing operation is performed. As a result, the brightness of the cells is increased by the larger number of sustain pulses applied thereto, and is more prominent.

To address this problem, in the first exemplary embodiment of the present invention, the pulse width of the top sustain pulse in each sustaining period in the first to fifth SFs is selectively lengthened. In this embodiment, the pulse width of the top sustain pulse in each sustaining period in the first to fifth SFs is set to as long as 5 microseconds. The pulse width of all the other sustain pulses is set to 2.5 microseconds. The conventional driving method has a problem of increasing the discharge delay in application of the top sustaining discharge pulse, when the wall voltage that has accumulated is less sufficient than that immediately after the normal writing operation. However, sufficiently large pulse width of the top sustain pulse in the sustaining period in the above manner can securely cause sustaining discharge, i.e. the erroneous discharge. After the sustaining discharge is caused by the erroneous discharge, selective initializing operation in the following initializing period can securely erase the wall charges. Thus, in the following SF, unnecessary sustaining discharge can be eliminated. In particular, lengthening the top sustaining pulses in the first to fifth SFs can securely cause erroneous discharges in the SFs up to the fifth SF, thereby inhibiting the brightness of the erroneous discharges to such an extent that can prevent deterioration of display quality. Now, the selective initializing operation in the initializing period refers to the operation of selectively initializing only the discharge cells that have undergone sustaining discharge in the sustaining period in the preceding SF. Specifically, application of a gradually-decreasing ramp waveform voltage to scan electrodes SCN1 to SCNn, as shown in the initializing period immediately after the sustaining period of the fifth SF of FIG. 4, causes selective initializing operation. This operation causes initializing discharge only in the discharge cells that have undergone sustaining discharge, including the erroneous discharge, in the preceding sustaining period, and decreases the excessive wall charges accumulating on the discharge cells to a value appropriate for the next writing operation. In the other discharge cells, the wall charges are kept as they are.

In the first exemplary embodiment, the pulse width of the top sustaining pulse in each sustaining period is set to 5 microseconds. However, the pulse width is not limited to this example. A pulse width ranging from 5 to 50 microseconds (inclusive) can provide similar advantages.

In the first exemplary embodiment of the present invention, the pulse width of the top sustain pulse in each sustaining period is selectively lengthened, as an example. However, the present invention is not limited to this example. For instance, only the pulse width of each top sustain pulse in the first and second SFs can be set longer. Alternatively, in combinations of some SFs, the pulse width of the sustain pulse in the top SF can be set longer than sustain pulses in the other SFs.

### Second Exemplary Embodiment

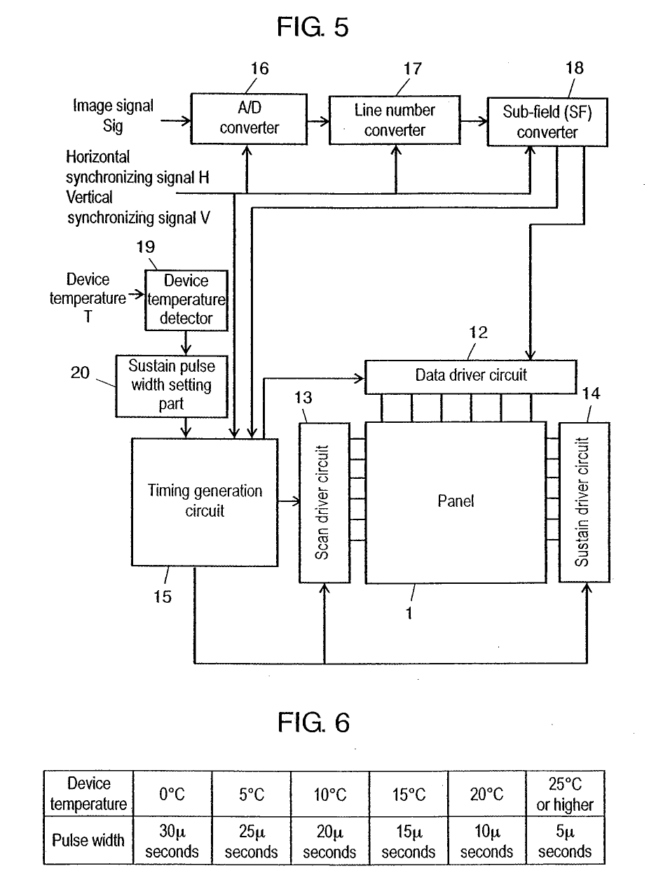

FIG. 5 is a circuit block diagram of a plasma display device in accordance with the second exemplary embodiment of the present invention. This plasma display device includes panel 1, data driver circuit 12, scan driver circuit 13, sustain driver circuit 14, timing generation circuit 15, analog-to-digital (A/D) converter 16, line number converter 17, and sub-field (SF) converter 18, power supply circuits (not shown), device temperature detector 19, and sustain pulse width setting part 20.

The second exemplary embodiment includes device temperature detector 19 and sustain pulse width setting part 20 in addition to the components of the first exemplary embodiment. This plasma display device is structured to determine and control the pulse width of the top sustain pulse in the sustaining period in each SF constituting one field, according to variations in the temperature of the plasma display device. Because the operation of the components other than device temperature detector 19 and sustain pulse width setting part 20 is the same as that of the first exemplary embodiment, descriptions thereof are omitted.

As shown in FIG. 5, device temperature T is detected by device temperature detector 19 and fed into sustain pulse width setting part 20. Sustain pulse width setting part 20 determines the pulse width of the top sustain pulse in the sustaining period in each SF, according to device temperature T, and generates a timing signal corresponding to the device temperature via timing generation circuit 15.

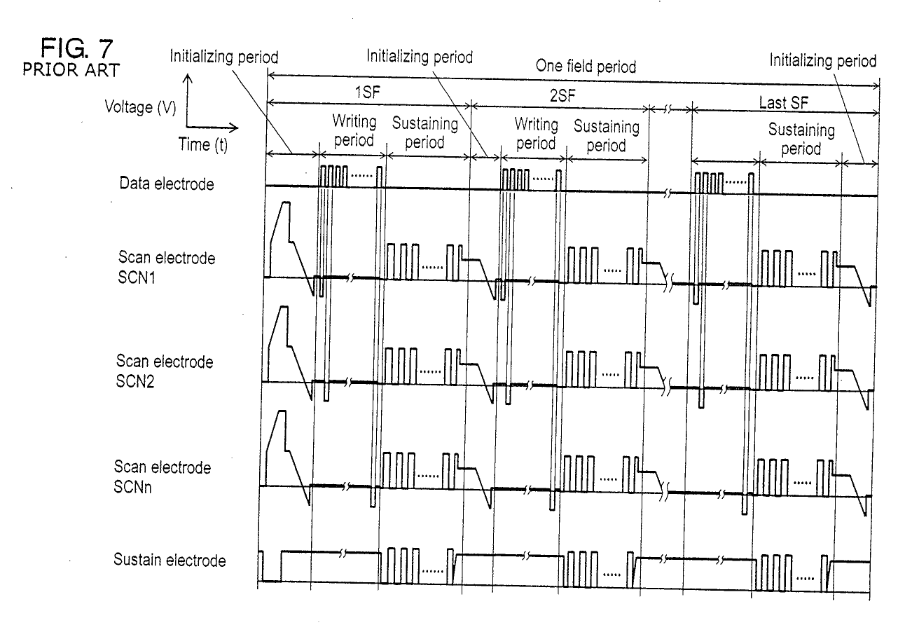

FIG. 6 shows an example of relation between a device temperature and a pulse width of the top sustain pulse in the sustaining period in each SF. As shown in FIG. 6, at a lower device temperature, the width of the sustain pulse is set longer. This is because an increase in discharge delay, i.e. a cause of the erroneous discharge, is more prominent at a lower temperature. In FIG. 6, at a device temperature of 25° C. or higher, the pulse width is set to 5 microseconds. However, as the device temperature decreases to 20, 15, 10, 5, and 0° C., the length of the pulse width is increased to 10, 15, 20, 25, and 30 microseconds. Setting the pulse widths in this manner can alleviate the influence of increased discharge delay and promptly cause erroneous discharges in the SFs having lower brightness weights, thereby preventing the erroneous discharges from occurring in the latter half of the SFs having higher brightness weights. In the second exemplary embodiment, FIG. 6 shows an example of settings of device temperatures and sustain pulse widths. However, the present invention is not limited to this combination of values. Although the pulse width of the top sustain pulse in the sustaining period is set to 30 microseconds at a device temperature of 0° C., the pulse width is not limited to this value. Setting a value ranging from 5 to 50 microseconds (inclusive) can provide similar advantages.

For a plasma display device, when the power is turned on and displaying images is continued, temperature increases caused by discharge of the discharge cells, and those in the power source, signal processor circuit, and driver circuits further increase the temperature of the device itself, even from a low temperature at the beginning. For this reason, the discharge delay prominent at low temperatures is shortened with temperature increases in the plasma display device, and the erroneous discharges do not occur. Because a higher-definition panel requires a longer writing period and thus only allows a shorter period to drive sustaining discharge, it is more difficult to ensure the number of pulses to securely provide a predetermined brightness. Thus, to ensure a necessary brightness, making the pulse width as small as possible, and ensuring the driving time in the sustaining period are necessary.

For the second exemplary embodiment, when the temperature of the plasma display device is increased, shortening the extended time of the top sustain pulse in the sustaining period in each SF can save the driving time, and ensure the driving time in the sustaining period.

As described above, for a method of driving a plasma display panel of the present invention, lengthening the pulse width of the top sustain pulse in the sustaining period limits the SFs having any erroneous discharge to the SFs having lower brightness weights. Thus, the method can inhibit the brightness of erroneous discharges more than the conventional method and display high-quality images.

### INDUSTRIAL APPLICABILITY

A method of driving a plasma display panel of the present invention is industrially useful to improve the display qualities of plasma display devices, because the method can inhibit the brightness of any erroneous discharge and display high-quality image.

1. A method of driving an AC plasma display panel, in which one field period is made of a plurality of sub-fields (SFs), each including an initializing period, writing period, and sustaining period, and a part of sustaining operation in one of the sustaining periods in at least one of the plurality of SFs and a part of selective initializing operation in one of the initializing periods in a SF following the at least one SF are performed at the same time, the method comprising: making a pulse width of a top sustain pulse in one of the sustaining periods in the plurality of SFs different from that in another of the sustaining periods therein.

2. The method of driving an AC plasma display panel of claim 1, wherein the pulse width of the top sustain pulse in the sustaining period in a specific one of the plurality of SFs is longer than pulse widths of sustain pulses in sustaining periods in other SFs.

3. The method of driving an AC plasma display panel of claim 2, wherein the specific SFs having the longer pulse widths in the top sustain pulses are a top SF and a SF selected from a plurality of following SFs in one field period.

4. The method of driving an AC plasma display panel of claim 2, wherein the specific SFs having the longer pulse widths in the top sustain pulses are a top SF and following SFs up to a fifth SF in one field period.

5. The method of driving an AC plasma display panel of claim 1, wherein the pulse width of the top sustain pulse in the sustaining period ranges from 5 to 50 microseconds (inclusive).

6. A method of driving an AC plasma display panel, in which one field period is made of a plurality of sub-fields (SFs), each including an initializing period, writing period, and sustaining period, and a part of sustaining operation in one of the sustaining periods of at least one of the plurality of SFs and a part of selective initializing operation in one of the initializing periods of a SF following the at least one SF are performed at the same time, the method comprising: varying pulse widths of top sustain pulses in the sustaining periods with a device temperature.

7. The method of driving an AC plasma display panel of claim 6 comprising: making a pulse width of a top sustain pulse in one of the sustaining periods in the plurality of SFs different from that in another of the sustaining periods therein.

8. The method of driving an AC plasma display panel of claim 7, wherein the pulse width of the top sustain pulse in the sustaining period in a specific one of the plurality of SFs is longer than pulse widths of sustain pulses in sustaining periods in other SFs.

9. The method of driving an AC plasma display panel of claim 8, wherein the specific SFs having the longer pulse widths in the top sustain pulses are a top SF, and a SF selected from a plurality of following SFs in one field period.

10. The method of driving an AC plasma display panel of claim 8, wherein the specific SFs having the longer pulse widths in the top sustain pulses are a top SF and following SFs up to a fifth SF in one field period.

11. The method of driving an AC plasma display panel of claim 6, wherein the pulse widths of the top sustain pulses in the sustaining periods range from 5 to 50 microseconds (inclusive).
